(19) United States
(12) Patent Application Publication
(10) Pub. No.: US 2011/0253688 A1
(43) Pub. Date: Oct. 20, 2011

(54) Laser Processing Method

(75) Inventors: Chien-Sheng HU, Taipei City (TW); Hung-Lung CHEN, Hsin Chu City (TW)

(73) Assignee: Epileds Technologies, Inc., Sinshih Township (TW)

(21) Appl. No.: 13/072,440

(22) Filed: Mar. 25, 2011

(30) Foreign Application Priority Data
Apr. 15, 2010 (TW) 099111887

(51) Int. Cl. B23K 26/38

(52) U.S. Cl. 219/121.69

(57) ABSTRACT

A laser processing method discloses a laser processing method, which emits a laser light onto an incidence plane of a wafer to form a trench on the wafer. The ratio of a depth of the trench to the thickness of the wafer is smaller than or equal to about 1/5. Make the laser light process the plural times of the back and forth indenting in the trench on the wafer with a high speed, whereupon there is no residuum near the trench such that the brightness of a light emitting diode (LED) can be increased, and make the wafer easier to be broken into dies.

### BACKGROUND OF THE INVENTION

1. Field of the Invention

The present invention relates to a laser processing method, and particularly to a laser processing method for increasing the brightness of a light emitting diode (LED) and making a wafer easier to be broken.

2. Description of the Related Art

Laser is widely applied in various fields, such as distance measurement, cutting of diverse soft and hard materials, laser medical treatment, etc. In the wafer cutting industry of the LED, the laser processing method is a new generation of cutting method after the diamond knife cutting method.

Please refer to FIG. 1A and FIG. 1B as schematic sectional views respectively illustrating wafer cutting and wafer breakage implemented by a conventional laser processing method. In the conventional laser processing method, a trench 22 is formed by emitting a laser light 1 onto an incidence plane 21 of a wafer 2. The ratio of the depth A of the trench 22 to the thickness B of the wafer 2 is between 1/3 and 1/4. Further, set the trench 22 as a central axis, and the wafer 2 is broken into dies in the opposite directions of the trench 22.

However, in the conventional laser processing, after the laser light 1 is emitted onto the incidence plane 21 of wafer 2, there is a residuum 3 made nearby the trench 22. The residuum 3 causes the light of LED cannot be led out. Besides, the residuum 3 will consume the brightness of LED by absorbing the light. With the stream of the wide application of LED, the demands of the LED's brightness and lumens per watt have become increasingly higher and higher and thus LED manufacturers cannot accept the fact of brightness consumption caused in the conventional laser processing. Thus, the residuum 3 is actually an issue to be solved in the wafer cutting industry of the LED.

Consequently, because of the technical defects of described above, the inventor keeps on carving unflaggingly through wholehearted experience and research to develop the present invention, which can effectively improve the defects described above.

### SUMMARY OF THE INVENTION

In view of the difficulties of the prior art, the inventor presents a laser processing method as an embodiment and an accordance to improve the above-mentioned defects base on years research and development and lots of practical experience.

One purpose of the present invention is to provide a laser processing method for forming at least one first trench along a first direction on a wafer moving with a second predetermined speed by at least one laser light moving with a first predetermined speed, and the ratio of a depth of the first trench to a thickness of the wafer is smaller than or equal to 1/5; and a first back and forth indenting in the first trench of the wafer with plural times by the laser light.

The present invention processes the back and forth indenting in the trench of the wafer with plural times by using the laser light with a predetermined high speed, and the plural times of the back and forth indenting can sweep the residuum nearby the trench away. Therefore, the plural times of the back and forth indenting make the vicinity of the trench without any residuum to prevent the condition that the light of LED cannot be led out, or be absorbed. In another word, the laser processing method according to the present invention can increase the brightness of LED.

In order that the review committees further understand the technical features and the achieved effect of the present invention, please refer to the preferred embodiments and the detailed description as below.

### BRIEF DESCRIPTION OF THE DRAWINGS

FIG. 1A is a schematic sectional view illustrating the wafer cutting by a conventional laser processing method;

FIG. 1B is a schematic sectional view illustrating the wafer breaking by the conventional laser processing method;

FIG. 2A is a schematic sectional view illustrating the wafer cutting by the laser processing method according to the present invention;

FIG. 2B is a schematic sectional view illustrating the wafer breaking by the laser processing method according to the present invention;

FIG. 3 is a schematic top view illustrating the wafer implemented by the laser processing method according to the present invention;

FIG. 4A and FIG. 4B are flow charts respectively illustrating a first type and a second type of a first embodiment of the laser processing method according to the present invention;

FIG. 5A and FIG. 5B are flow charts respectively illustrating a first type and a second type of a second embodiment of the laser processing method according to the present invention;

FIG. 6 is a schematic view illustrating the wafer broken into dies by the laser processing method according to the present invention; and

FIG. 7 is a schematic view illustrating the laser equipment in the laser processing method according to the present invention.

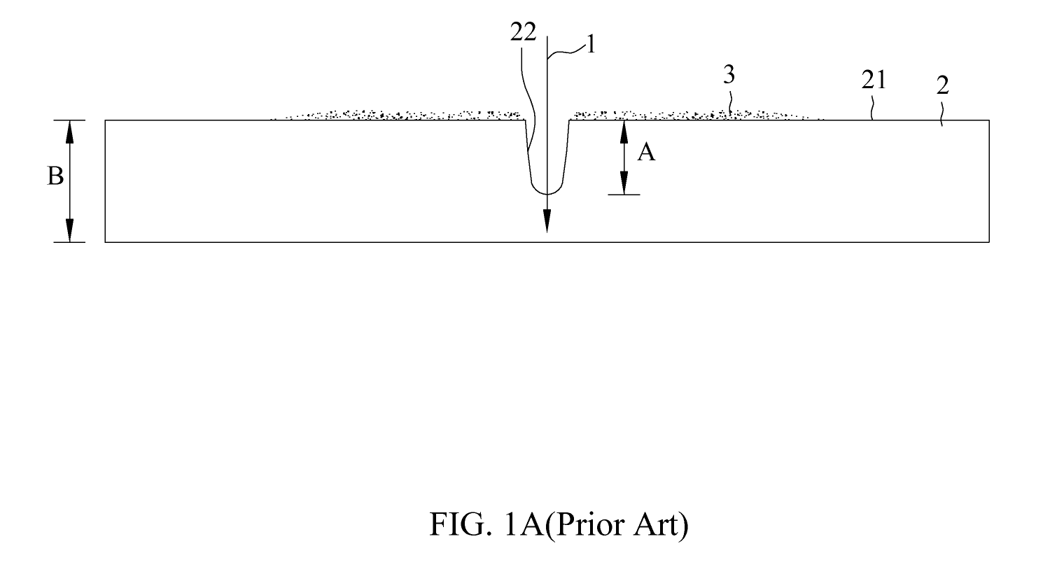

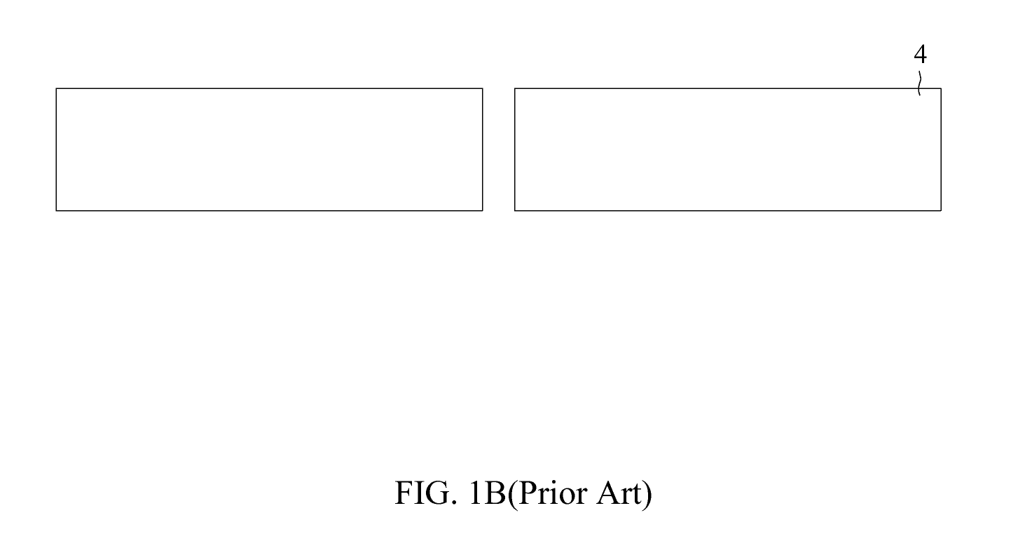

### DETAILED DESCRIPTION OF THE PREFERRED EMBODIMENTS

Thereinafter, the present invention will be described with the preferred embodiments referring to the related figures, and for easy to understand, the identical elements of the following embodiments are marked with the same symbol.

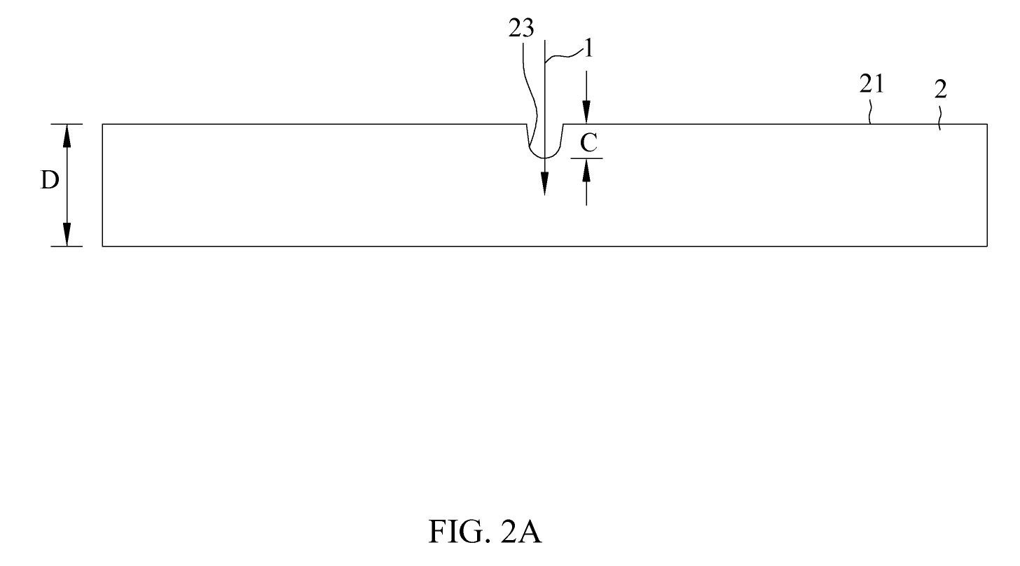

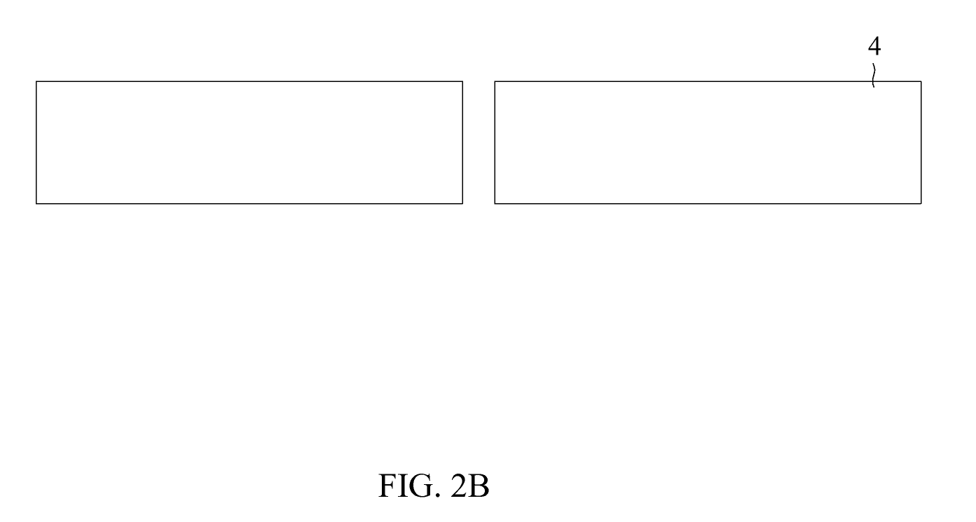

First of all, please refer to FIG. 2A and FIG. 2B, which show respectively schematic sectional views illustrating the wafer cutting and the wafer breaking by the laser processing method according to the present invention. As shown in FIG. 2A, the laser processing method according to the present invention emits a laser light 1 onto an incidence plane 21 of a wafer 2 to cut the wafer 2 and form a first trench 23. The ratio of a depth C of the first trench 23 to the thickness C of the wafer 2 (the depth C divided by the thickness D of the wafer 2) is, for example, smaller than or equal to about 1/5. Then, set the trench 23 as the center, and the wafer 2 is broken into dies 4 in the opposite directions of the trench 23 as shown in FIG. 2B.

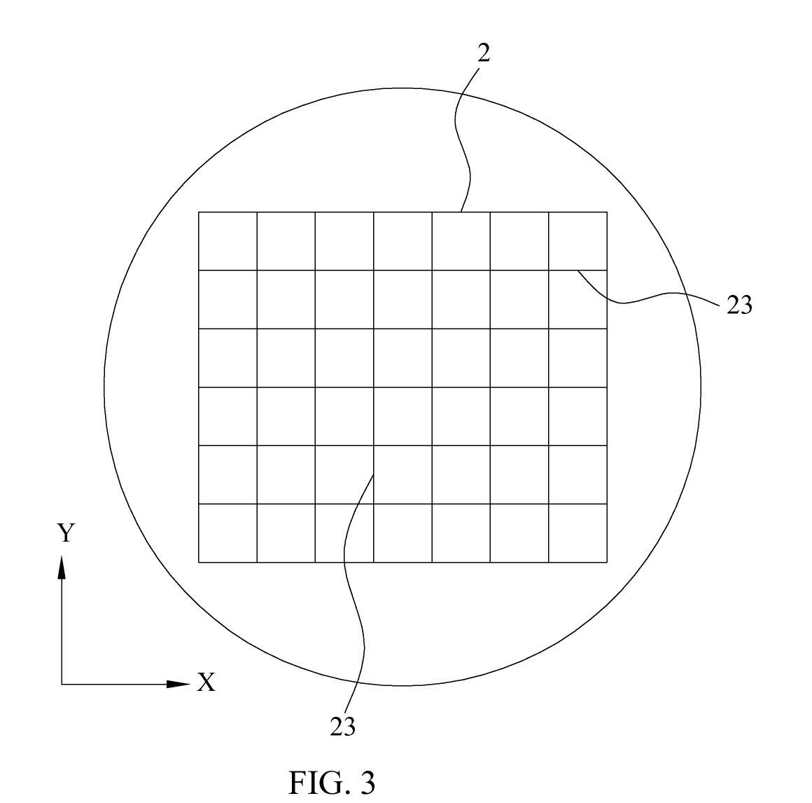

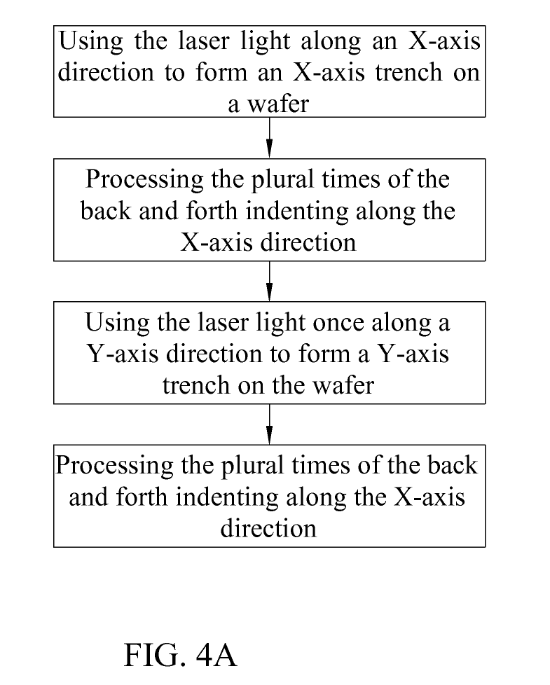

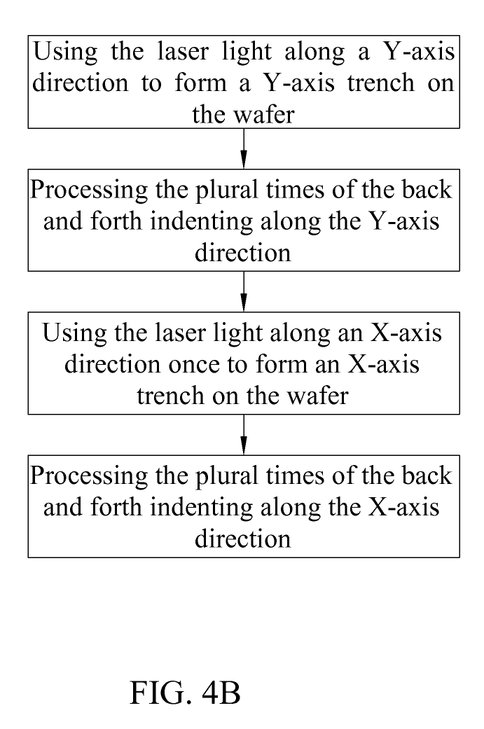

Please refer to FIG. 3, FIG. 4A, and FIG. 4B, which show respectively a schematic top view illustrating the wafer implemented by the laser processing method according to the present invention and flow charts of the laser processing method. What we especially explain here, as shown in FIG. 4A, a first type of a first embodiment according to the present invention, a wafer 2 is immovable, namely the moving speed of wafer 2 is zero, and a set of laser equipment, such as a Q-Switch laser equipment, emits a laser light 1 with wavelength, for example, between 192 nm and 1064 nm, at a frequency ranging, for example, from 50 KHz to 200 KHz, and makes the laser light 1 cut the immovable wafer 2 to from an X-axis trench 23 along a first direction, for example, X-axis direction, with a predetermined moving speed, for example, a high speed, which is preferred between around 20 mm/s and 600 mm/s and more preferred between around 80 mm/s and 200 mm/s. The laser light 1 processes the plural times of the back and forth indenting on the X-axis trench 23 continuously along the X-axis direction for sweeping away the residuum caused in the cutting step. Next, along a second direction crossing the first direction, such as a Y-axis direction, the laser light 1 cuts the wafer 2 to form a Y-axis trench 23 and continuously processes the plural times of the back and forth indenting on the Y-axis trench 23 along the Y-axis direction, for example, at least 2 times of the back and forth indenting.

According to a second type of the first embodiment in accordance with the present invention as shown in FIG. 4B, the wafer 2 is same immovable, the laser processing method according the present invention makes the laser light 1 cut the immovable wafer 2 to form a Y-axis trench 23 firstly along a Y-axis direction with a predetermined moving speed, for example, a high speed, which is preferred between around 20 mm/s and 600 mm/s and more preferred between around 80 mm/s and 200 mm/s. The laser light 1 processes the plural times of the back and forth indenting on the Y-axis trench 23 continuously along the Y-axis direction. Next, along the first direction crossing the second direction, such as an X-axis direction, the laser light 1 cuts the wafer 2 to form an X-axis trench 23 and continuously processes the plural times of the back and forth indenting on the X-axis trench 23 along the first direction, for example, at least 2 times of the back and forth indenting.

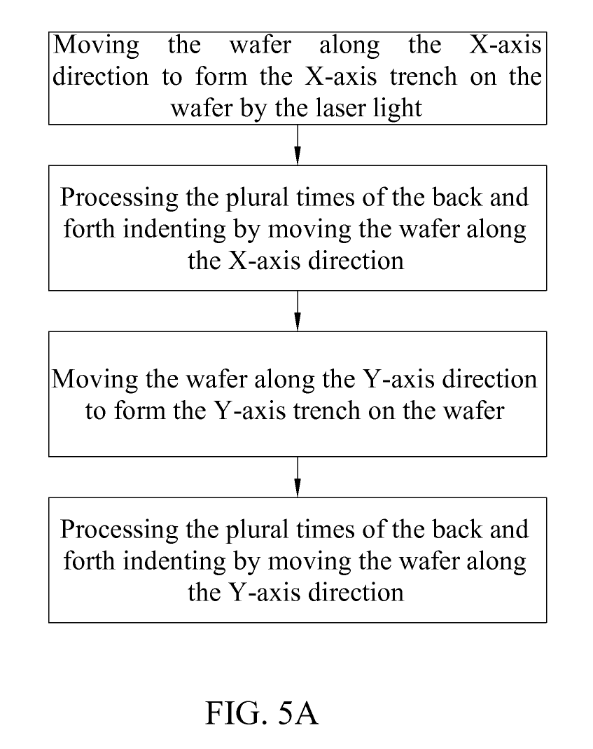

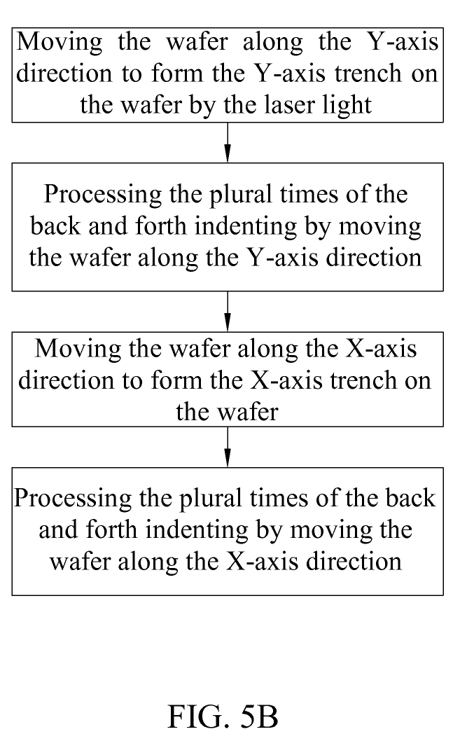

Please refer to FIG. 5A and FIG. 5B, which show respectively flow charts of a first type and a second type of a second embodiment according to the present invention. As shown in FIG. 5A, the flow chart illustrates a first type of a second embodiment according to the present invention, the laser light 1 is immovable, namely the moving speed of laser light 1 is zero. Make the wafer 2 move along the X-axis direction to form an X-axis trench 23 on the wafer 2 with the predetermined moving speed, for example, a high speed, which is preferred between around 20 mm/s and 600 mm/s and more preferred around 80 mm/s and 200 mm/s. The wafer 2 is back and forth moved along the X-axis direction to process the plural times of the back and forth indenting on the X-axis trench 23. Next, make the wafer 2 move along the second direction crossing the first direction, such as the Y-axis direction to form the Y-axis trench 23 on the wafer 2, and the wafer 2 is back and forth moved along the second direction to process the plural times of the back and forth indenting on the Y-axis trench 23, for example, at least 2 times of the back and forth indenting. According to the second type of the second embodiment according to the present invention as shown in FIG. 5B, the laser light 1 is same immovable, move the wafer 2 to form the Y-axis trench 23 firstly along the Y-axis direction with the predetermined moving speed, for example, the high speed, which is preferred between around 20 mm/s and 600 mm/s and is more preferred around 80 mm/s and 200 mm/s. The wafer 2 is back and forth moved along the Y-axis direction to process the plural times of the back and forth indenting on the Y-axis trench 23, for example, at least 2 times of the back and forth indenting. Next, move the wafer 2 to form the X-axis trench 23 on the wafer 2 along the first direction crossing the second direction, such as the X-axis direction, and back and forth move the wafer 2 along the first direction to process the plural times of the back and forth indenting on the X-axis trench 23, for example, at least 2 times of the back and forth indenting.

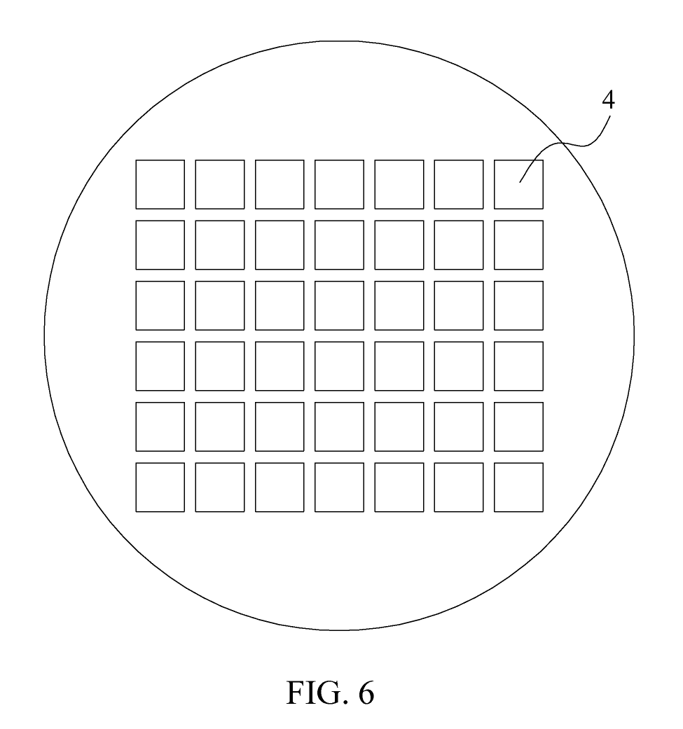

Furthermore, please also refer to FIG. 6, which shows a schematic view illustrating the wafer breaking by the laser processing method according to the present invention. According to the first and the second embodiments of the laser processing method, after the laser cutting is completed, namely the plural times of the back and forth indenting is processed, set the first or the second direction trench 23 as the central axis, and the wafer 2 is broken into dies 4 in the opposite directions of the trench 23.

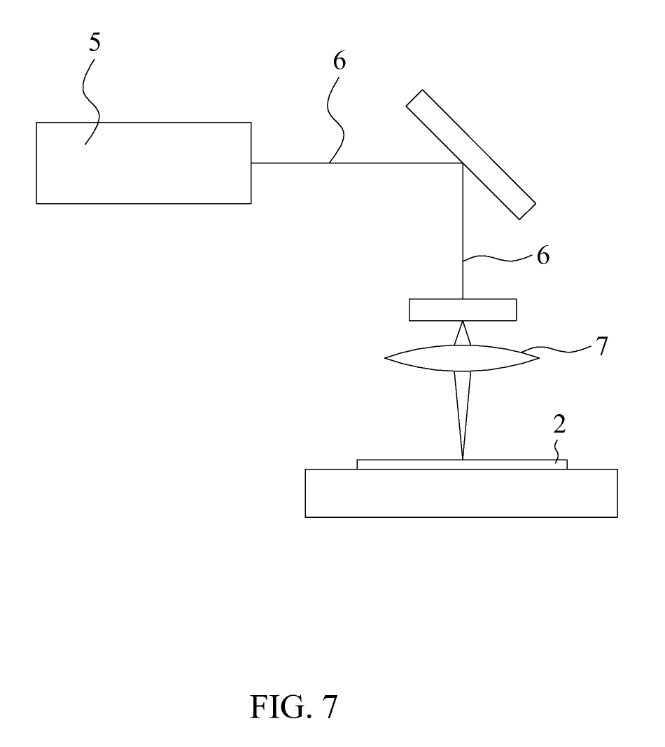

Please refer to FIG. 7, which shows a schematic view illustrating the laser equipment according to the present invention. As shown in FIG. 7, the laser equipment 5 is used to emit at least one single-channel laser light 6, and the laser light 6 is made to focus on the wafer 2 through an optical lens 7 to cut the wafer 2.

To sum up, the laser processing method according to The present invention at least has the following advantages:

1. The present invention processes the back and forth indenting in the trench of the wafer with plural times by using the laser light with a predetermined high speed, and the plural times of the back and forth indenting can sweep the residuum nearby the trench away. Therefore, the plural times of the back and forth indenting make the vicinity of the trench without any residuum to prevent the condition of the light of LED not being led or being absorbed. In another word, the laser processing method can increase the brightness of LED.

2. According to the laser processing method according the present invention, the ratio of the depth of the trench to the thickness of wafer is smaller than or equal to about 1/5, thus the wafer is easier to be broken.

The foregoing detailed description should be regarded as illustrative rather than limiting and the appended claims including all equivalents are intended to define the scope of the invention.

What is claimed is:

1. A laser processing method, comprising the steps of:
forming at least one first trench along a first direction on a wafer moving with a second predetermined speed by at least one laser light moving with a first predetermined speed, wherein the ratio of a depth of the first trench to a thickness of the wafer is smaller than or equal to 1/5; and
processing a first back and forth indenting in the first trench of the wafer with plural times by the laser light.

2. The laser processing method according to claim 1, after the first back and forth indenting, further comprising:
forming at least one second trench of the wafer along a second direction by the laser light, wherein the ratio of a depth of the second trench to a thickness of the wafer is smaller than or equal to 1/5; and
processing a second back and forth indenting in the second trench of the wafer with plural times by the laser light.

3. The laser processing method according to claim 1, wherein the wavelength of laser light is between 192 nm and 1064 nm.

4. The laser processing method according to claim 1, wherein the laser light is emitted by a Q-switch laser equipment.

5. The laser processing method according to claim 4, wherein the Q-switch laser equipment emits the laser light at a frequency ranging from 50 kHz to 200 kHz.

6. The laser processing method according to claim 1, wherein the first direction and the second direction are respectively an X-axis direction and a Y-axis direction that cross, or the first direction and the second direction are a Y-axis direction and an X-axis direction that cross.

7. The laser processing method according to claim 1, wherein the first predetermined moving speed is between 80 mm/s and 200 mm/s and the second predetermined moving speed is zero or the second predetermined moving speed is between 80 mm/s and 200 mm/s and the first predetermined moving speed is zero.

8. The laser processing method according to claim 2, wherein the wavelength of laser light is between 192 nm and 1064 nm.

9. The laser processing method according to claim 2, wherein the laser light is emitted by a Q-switch laser equipment.

10. The laser processing method according to claim 7, wherein the Q-switch laser equipment emits the laser light at a frequency ranging from 50 kHz to 200 kHz.
